(19) United States
(12) Patent Application Publication
(10) Pub. No.: US 2026/0225345 A1
(43) Pub. Date: Aug. 6, 2026

(54) CARBON FIBER VEIL-BASED LIGHTWEIGHT FREQUENCY-SELECTIVE METAMATERIAL WITH INTEGRATED ABSORPTION-TRANSMISSION TO ELECTROMAGNETIC WAVES AND PREPARATION METHOD THEREOF

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Guanyu HAN, Taiyuan (CN); Guizhe ZHAO, Taiyuan (CN)

(21) Appl. No.: 19/578,355

(22) Filed: Mar. 25, 2026

Related U.S. Application Data
(63) Continuation of application No. PCT/CN2025/105710, filed on Jun. 30, 2025.

(30) Foreign Application Priority Data
Jun. 18, 2025 (CN) 202510816969.4

(51) Int. Cl. B32B 7/025; B32B 5/02; B32B 5/26

(52) U.S. Cl. CPC B32B 7/025; B32B 5/02; B32B 5/26; B32B 2250/03; B32B 2250/40; B32B 2260/021; B32B 2260/046; B32B 2262/101; B32B 2262/106; B32B 2307/20; B32B 2307/718; B32B 2307/7376

(57) ABSTRACT

A carbon fiber veil-based lightweight frequency-selective metamaterial with integrated absorption-transmission to electromagnetic waves, including a symmetric structure composed of at least one unit arranged periodically. Each unit includes a first frequency-selective metastructure layer, a dielectric layer, and a second frequency-selective metastructure layer laminated in sequence from bottom to top, where the second frequency-selective metastructure layer is a lossy frequency-selective metastructure. A unit structure of the first frequency-selective metastructure layer has a square-ring shape. A unit structure of the dielectric layer is square-shaped. A unit structure of the second frequency-selective metastructure layer has a cross shape. A method for preparing such metamaterial is also provided.

### CROSS-REFERENCE TO RELATED APPLICATIONS

This application is a continuation of International Patent Application No. PCT/CN2025/105710, filed on June 30, 2025, which claims the benefit of priority from Chinese Patent Application No. 202510816969.4, filed on June 18, 2025. The content of the aforementioned application, including any intervening amendments thereto, is incorporated herein by reference in its entirety.

### TECHNICAL FIELD

This application relates to functional composites, and more particularly to a carbon fiber veil-based lightweight frequency-selective metamaterial with integrated absorption-transmission to electromagnetic waves and a preparation method thereof.

### BACKGROUND

The environmental electromagnetic wave (EMW) radiation will interfere with the normal operation of devices sensitive to EMW, such as civil aircraft radios, radars, and aerospace data transceivers, and also potentially threaten human health. Moreover, the rapid development of the artificial intelligence and the popularization of 5G communication exacerbate this issue. Therefore, the research and development of EMW-absorbing materials, which can convert the invasive EMWs into heat without causing secondary pollution, have attracted considerable attention.

Metamaterials, as artificial electromagnetic periodic structures, can exhibit extraordinary physical properties and effects through the unit pattern design, enabling the impedance adjustment and precise electromagnetic field control at the structure level. This exceptional design flexibility provides strong support for customized electromagnetic responses. As an application branch of metamaterials, metamaterial absorbers are capable of absorbing or scattering electromagnetic waves, or altering the propagation direction of electromagnetic waves, and thus can be used in reducing the electromagnetic interference, enhancing the stealth performance, and improving the solar cell efficiency. Research on metamaterial absorbers involves multiple disciplines, including physics, material science, and electronic engineering, making it a challenging yet highly promising field. To achieve the precise structural design, it is necessary to select materials with excellent and stable electrical conductivity as the base of metamaterials. In this regard, metal materials with superior conductivity and processability have been widely used in the design and fabrication of traditional metamaterials. However, inherent limitations of metals, including susceptibility to corrosion, high weight, and poor interfacial properties, severely hinder the practical performance of these metal-based metamaterials.

In recent years, the rapid development of carbon fiber materials has provided potential solutions to overcome the limitations of conventional metal-based metamaterials. Compared with metal materials, carbon fibers possess superior corrosion resistance, light weight, and excellent interfacial properties, which can effectively remedy the deficiencies of traditional metal-based metamaterials in the practical applications. Although carbon fibers exhibit lower electrical conductivity than metals, this inherent property endows them with a natural resistivity. Therefore, compared to conventional metal-based metamaterials, carbon fiber-based novel metamaterials have an additional adjustable material dimension, offering enhanced flexibility for performance control and structural design.

Frequency selective surfaces (FSS), as a novel type of electromagnetic wave absorbing material, are composed of periodic unit structures formed by patches or apertures. Through structural regulation of these patches and apertures, FSS can achieve transparent transmission or strong reflection of electromagnetic waves within the target frequency band. Based on this, the derived frequency selective absorbing surfaces can absorb the electromagnetic waves outside the passband frequency range. Conventional metallic FSSs are limited by the heavy weight and narrow absorption bandwidth. In contrast, the novel FSSs fabricated from carbon-based conductive composites offer advantages including light weight, and excellent resistance to corrosion and high temperature. Particularly, the carbon-based conductive composites can effectively broaden the absorption bandwidth, and thus receive considerable attention.

### SUMMARY

An object of the disclosure is to provide a carbon fiber veil-based frequency-selective metamaterial with integrated absorption-transmission to electromagnetic waves and a preparation method thereof, so as to overcome the problems of high specific gravity and complex fabrication process in the conventional metamaterial absorbers.

Technical solutions of the present disclosure are described as follows.

In a first aspect, this application provides a carbon fiber veil-based frequency-selective metamaterial with integrated absorption-transmission to electromagnetic waves, comprising: a symmetric structure composed of n × n units arranged periodically; wherein n is a positive integer; each of the n × n units comprises a first frequency-selective metastructure layer, a dielectric layer, and a second frequency-selective metastructure layer laminated in sequence from bottom to top; and the second frequency-selective metastructure layer is a lossy frequency-selective metastructure layer; a unit structure of the first frequency-selective metastructure layer has a square-ring shape, having an outer-side length a₁ of 15.23-23.71 mm and an inner-side length a₂ of 9.10 -14.33 mm, and a₂ < a₁; the unit structure of the first frequency-selective metastructure layer is fabricated by laminating a first carbon fiber veil having a sheet resistance of 3-5 Ω/sq and an areal density of 40-80 g/m² with a first quartz fiber fabric/epoxy composite; a center of the unit structure of the first frequency-selective metastructure layer has a square-shaped recess with the first carbon fiber veil removed to expose the first quartz fiber fabric/epoxy composite, such that the square-shaped recess is surrounded by peripheral edges covered with the first carbon fiber veil; the first frequency-selective metastructure layer has a reflection behavior similar to that of a perfect electric conductor within an absorption band, and offers a transmission effect within a transmission band via an inductor-capacitor (LC) parallel resonance; a unit structure of the dielectric layer is square, and has a side length of a₁ and a thickness h of 3.20-9.16 mm; in response to a case that h varies within a range of 3.20-9.16 mm, an absorption band and a transmission band of the frequency-selective metamaterial remain near a series resonance point of the second frequency-selective metastructure layer and a parallel resonance point of the first frequency-selective metastructure layer, respectively; the dielectric layer is made of a polystyrene foam board; a unit structure of the second frequency-selective metastructure layer has a cross shape, and has a unit size of b, b=a₁, an arm length b₁of 15.00-20.75 mm and an arm width b₂of 1.51-3.25 mm, wherein b₂ < b₁ < b; the unit structure of the second frequency-selective metastructure layer is fabricated by laminating a second carbon fiber veil having a sheet resistance of 4-25 Ω/sq and an areal density of 5-50 g/m² with a second quartz fiber fabric/epoxy composite; the unit structure of the second frequency-selective metastructure layer has a cross-shaped protrusion formed by removing the second carbon fiber veil within peripheral regions to expose the second quartz fiber fabric/epoxy composite; the second frequency-selective metastructure layer achieves impedance matching through LC series resonance within the absorption band, and offers a transmission effect via LC parallel resonance within the transmission band; and the second frequency-selective metastructure layer as a top layer and the first frequency-selective metastructure layer as a bottom layer are configured to jointly produce parallel resonance within the transmission band to enable effective transmission of the electromagnetic waves.

In some embodiments, the first carbon fiber veil has a thickness of 0.05-1 mm; and the first quartz fiber fabric/epoxy composite has a thickness of 0.5-5 mm.

In some embodiments, the second carbon fiber veil has a thickness of 0.05-1 mm; and the second quartz fiber fabric/epoxy composite has a thickness of 0.5-5 mm.

In some embodiments, the unit structure of the first frequency-selective metastructure layer, the unit structure of the dielectric layer, and the unit structure of the second frequency-selective metastructure layer are arranged in a one-to-one correspondence manner from bottom to top.

In a second aspect, this application provides a method for preparing the lightweight frequency-selective metamaterial described above, comprising: (1) obtaining a square-shaped carbon fiber veil with a side length of n × a₁ and 2-10 square-shaped quartz fiber fabrics with a side length of n × a₁by cutting; preparing an epoxy resin adhesive; sequentially laminating the 2-10 square-shaped quartz fiber fabrics, and applying the epoxy resin adhesive to each of the 2-10 square-shaped quartz fiber fabrics to ensure full impregnation followed by compaction to obtain a quartz fiber fabric laminate; and impregnating the carbon fiber veil with the epoxy resin adhesive followed by placement on the quartz fiber fabric laminate to obtain a first carbon fiber veil-quartz fiber fabric/epoxy resin prepreg for the first frequency-selective metastructure layer; and repeating the above steps to prepare a second carbon fiber veil-quartz fiber fabric/epoxy resin prepreg for the second frequency-selective metastructure layer; (2) uniformly applying a release agent to a surface of a mold, loading the first carbon fiber veil-quartz fiber fabric/epoxy resin prepreg or the second carbon fiber veil-quartz fiber fabric/epoxy resin prepreg into the mold, respectively, followed by mold closing , curing at 120°C and 15 MPa, natural cooling to room temperature and demolding to obtain a first carbon fiber veil-quartz fiber fabric/epoxy resin composite plate for the first frequency-selective metastructure layer or a second carbon fiber veil-quartz fiber fabric/epoxy resin composite plate for the second frequency-selective metastructure layer; (3) fixing the first carbon fiber veil-quartz fiber fabric/epoxy resin composite plate to a processing platform of an engraving machine; removing carbon fiber veil from selected regions of the first carbon fiber veil-quartz fiber fabric/epoxy resin composite plate by using a milling cutter to form n × n square-ring recesses to expose quartz fiber fabric/epoxy composite, so as to form the first frequency-selective metastructure layer; and; fixing the second carbon fiber veil-quartz fiber fabric/epoxy resin composite plate to the processing platform of the engraving machine; removing carbon fiber veil from selected regions of the second carbon fiber veil-quartz fiber fabric/epoxy resin composite plate by using the milling cutter to form n × n cross-shaped protrusions, wherein quartz fiber fabric/epoxy composite within peripheral regions surrounding the cross-shaped protrusions are exposed, so as to form the second frequency-selective metastructure layer; and (4) adhesively bonding a quartz fiber fabric/epoxy composite side of the first frequency-selective metastructure layer to a first surface of a polystyrene foam board, and adhesively bonding a quartz fiber fabric/epoxy composite side of the second frequency-selective metastructure layer to a second surface of the polystyrene foam board followed by compaction to obtain the lightweight frequency-selective metamaterial.

Compared to the prior art, the present disclosure has the following beneficial effects.

(1) By coupling multilayer periodic unit arrays, the carbon fiber veil-based frequency-selective metamaterial is used to replace the widely used metal-patterned metamaterials, resulting in the metamaterial with integrated absorption-transmission to electromagnetic waves that is low-cost, easy to manufacture, lightweight, and easily tunable within frequency band. In the present disclosure, the carbon fiber veil-based frequency-selective metamaterial is employed in place of conventional metal-patterned metamaterials widely used, and are combined with quartz fiber reinforced epoxy composite plates, whereby the overall metamaterial is endowed with advantages such as light weight, corrosion resistance, and high-temperature resistance.

(2) The parameters of the specific structure are adjusted according to actual requirements, and desired electromagnetic wave transmission and absorption bands are obtained by modifying the electrical property parameters of the metamaterial. Excellent transmission performance is achieved within the required operating frequency band, with a minimum insertion loss of -1.14 dB, and superior absorption performance is attained, with an absorption rate exceeding 0.9.

### BRIEF DESCRIPTION OF THE DRAWINGS

The accompanying drawings are provided to facilitate the understanding of the technical solutions of the present disclosure, and form a part of the specification to illustrate the disclosure together with the embodiments. The accompanying drawings are illustrative and exemplary, and are not intended to limit the disclosure.

In order to illustrate the technical solutions in the embodiments of the present disclosure or the prior art more clearly, the needed accompanying drawings will be briefly described below. Obviously, presented in the accompanying drawings are only some embodiments of the present disclosure, and for those of ordinary skill in the art, other accompanying drawings can be obtained from the structures illustrated therein without making creative effort.

FIGS. 1A-1B schematically show a unit structure of a carbon fiber veil-based lightweight frequency-selective metamaterial with integrated absorption-transmission to electromagnetic waves according to an embodiment of the present disclosure, where A: front view; and B: rear view;

FIG. 2 schematically shows a unit structure of a second frequency-selective metastructure layer according to an embodiment of the present disclosure;

FIG. 3 schematically shows a unit structure of a first frequency-selective metastructure layer according to an embodiment of the present disclosure;

FIG. 4 is a photograph showing the lightweight frequency-selective metamaterial prepared in Example 1 of the present disclosure from the front side;

FIG. 5 is a photograph showing the lightweight frequency-selective metamaterial prepared in Example 1 of the present disclosure from the back side;

FIGS. 6A-6D respectively show absorption rate curves of the lightweight frequency-selective metamaterials prepared in Examples 1-4 of the present disclosure to EMWs within the frequency range of 2-18 GHz;

FIGS. 7A-7D respectively show S-parameter curves of the lightweight frequency-selective metamaterials prepared in Examples 1-4 of the present disclosure within the frequency range of 2-18 GHz.

### DETAILED DESCRIPTION OF EMBODIMENTS

To facilitate the understanding of the objectives, features, and advantages of the present disclosure, the disclosure will be described in detail below with reference to embodiments and accompanying drawings. It should be noted that the embodiments of the present disclosure and the features therein may be combined in the absence of contradiction.

Many specific details are provided below to facilitate a comprehensive understanding of the present disclosure. However, it should be noted that the disclosure may be implemented in ways other than those explicitly described herein. It is obvious that described herein are merely some embodiments of the present disclosure, instead of all embodiments.

The embodiments of the present disclosure are described in detail below.

In the following embodiments, the polystyrene foam board is purchased from Shanxi Sihai Youcheng Building Materials Technology Co., Ltd.

### EXAMPLE 1

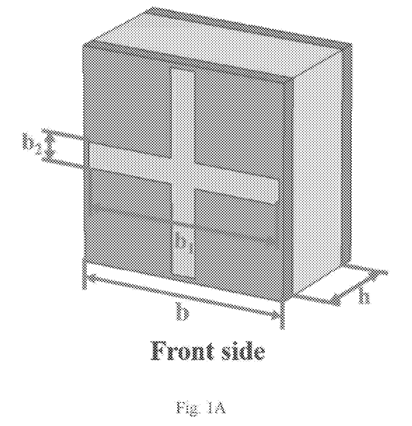

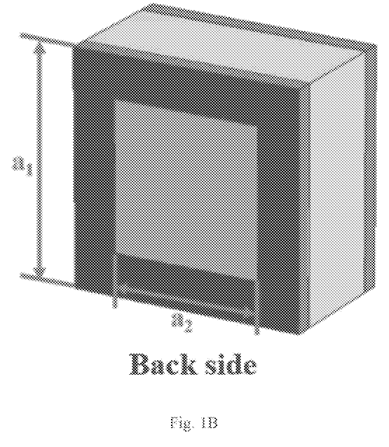

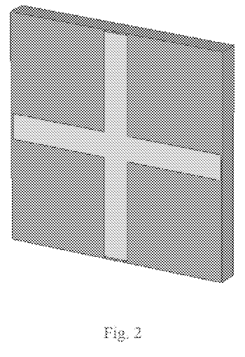

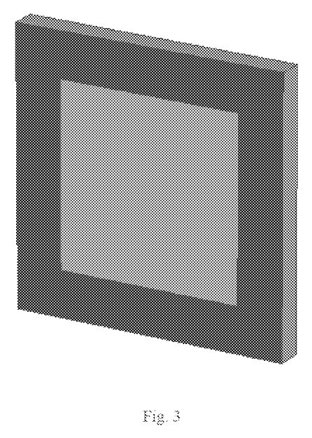

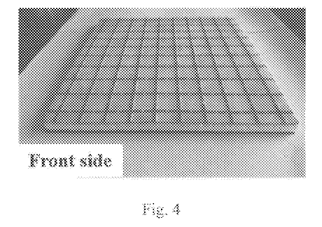

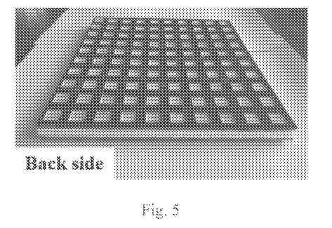

Provided herein is a carbon fiber veil-based lightweight frequency-selective metamaterial with integrated absorption-transmission to electromagnetic waves, which has a symmetric structure composed of 10 × 10 units arranged periodically as shown in FIGS. 1A-1B. Each unit includes a first frequency-selective metastructure layer, a dielectric layer, and a second frequency-selective metastructure layer laminated in sequence from bottom to top. The second frequency-selective metastructure layer is a lossy frequency-selective metastructure layer.

A unit structure of the first frequency-selective metastructure layer has a square-ring shape having an outer-side length a₁ of 18 mm and an inner-side length a₂ of 11.48 mm. The unit structure of the first frequency-selective metastructure layer is fabricated by laminating a first carbon fiber veil having a sheet resistance of 4 Ω/sq and an areal density of 50 g/m² with a first quartz fiber fabric/epoxy resin composite, where the first carbon fiber veil has a thickness of 1 mm, and the first quartz fiber fabric/epoxy resin composite has a thickness of 2 mm.

The dielectric layer has a thickness h of 7.9 mm.

A unit structure of the second frequency-selective metastructure layer has a cross shape, and has a unit size b of 18 mm, an arm length b₁ of 17.16 mm and an arm width b₂ of 2.16 mm. The unit structure of the second frequency-selective metastructure layer is fabricated by laminating a second carbon fiber veil having a sheet resistance of 25 Ω/sq and an areal density of 5 g/m² with a second quartz fiber fabric/epoxy resin composite, where the second carbon fiber veil has a thickness of 0.05 mm, and the second quartz fiber fabric/epoxy resin composite has a thickness of 3 mm.

The lightweight frequency-selective metamaterial described above is prepared as follows.

(1) Preparation of E-51 epoxy resin adhesive

A curing agent cis-1,2-cyclohexanedicarboxylic anhydride (HHPA) is preheated in an oven at 70 °C until liquefied. E-51 epoxy resin and HHPA are weighed at a weight ratio of 1:0.8 and subjected to mechanical stirring at 500 rpm and ultrasonic dispersion at 100 W in a 60 °C water bath to ensure thorough mixing, followed by addition of 0.1 wt.% of an accelerator, 2,4,6-tris(dimethylaminomethyl)phenol (DMP-30), and 0.3 wt.% of a silicone-based defoamer. Defoaming is performed in a vacuum oven at 70 °C for 30 min to yield the epoxy resin adhesive.

(2) Preparation of carbon fiber veil-quartz fiber fabric/epoxy resin prepreg

Four quartz fiber fabrics with a side length of 180 × 180 mm and a first short-cut carbon fiber veil (SCFV) for the first frequency-selective metastructure layer with a side length of 180 × 180 mm are cut. The four quartz fiber fabrics are weighed, and E-51 epoxy resin adhesive is measured at 40% by volume of a first SCFV-quartz fiber fabric/epoxy resin prepreg. The four quartz fiber fabrics are sequentially laminated, and the epoxy resin adhesive is applied on each of the four quartz fiber fabrics to ensure full impregnation and compacted to obtain a first quartz fiber fabric laminate. The first SCFV for the first frequency-selective metastructure layer is impregnated with the epoxy resin adhesive and placed on the first quartz fiber fabric laminate to obtain the first SCFV-quartz fiber fabric/epoxy resin prepreg for the first frequency-selective metastructure layer.

Six quartz fiber fabrics with a side length of 180 × 180 mm and a second short-cut carbon fiber veil (SCFV) for the second frequency-selective metastructure layer with a side length of 180 × 180 mm are cut. The six quartz fiber fabrics are weighed, and E-51 epoxy resin adhesive is measured at 40% by volume of a second SCFV-quartz fiber fabric/epoxy resin prepreg. The six quartz fiber fabrics are sequentially laminated, and the epoxy resin adhesive is applied on each of the six quartz fiber fabrics to ensure full impregnation and compacted to obtain a second quartz fiber fabric laminate. The second SCFV for the second frequency-selective metastructure layer is impregnated with the epoxy resin adhesive and placed on the second quartz fiber fabric laminate to form the second SCFV-quartz fiber fabric/epoxy resin prepreg for the second frequency-selective metastructure layer.

(3) Preparation of first frequency-selective metastructure layer and second frequency-selective metastructure layer by hot pressing and machining

A surface of a 250×250 mm steel mold is uniformly coated with a release agent and fully preheated in an oven at 100°C. The first SCFV-quartz fiber fabric/epoxy resin prepreg or the second SCFV-quartz fiber fabric/epoxy resin prepreg is laid on a bottom plate of the mold and pre-polymerized on a hot press at 100°C for 30 min. After pre-polymerization, the mold is closed and subjected to a pressure of 15 MPa, followed by curing at 120 °C for 2 h by using the hot press. After pressure maintenance and natural cooling to room temperature, demolding is performed to obtain a first SCFV-quartz fiber fabric/epoxy resin composite plate for the first frequency-selective metastructure layer or a second SCFV-quartz fiber fabric/epoxy resin composite plate for the second frequency-selective metastructure layer.

(4) The first SCFV-quartz fiber fabric/epoxy resin composite plate is fixed to a processing platform of an engraving machine. Carbon fiber veil from selected regions of the first SCFV-quartz fiber fabric/epoxy resin composite plate is removed by using a milling cutter to form 10 × 10 square-ring recesses to expose quartz fiber fabric/epoxy resin composite, so as to form the first frequency-selective metastructure layer.

The second SCFV-quartz fiber fabric/epoxy resin composite plate is fixed to the processing platform of the engraving machine. Carbon fiber veil from selected regions of the second SCFV-quartz fiber fabric/epoxy resin composite plate is removed by using the milling cutter to form 10 × 10 cross-shaped protrusions, where quartz fiber fabric/epoxy composite within peripheral regions surrounding the cross-shaped protrusions are exposed, so as to form the second frequency-selective metastructure layer.

(5) Assembly and preparation of carbon fiber veil-based lightweight frequency-selective metamaterial with integrated absorption-transmission to electromagnetic waves:

A quartz fiber fabric/epoxy composite side of the first frequency-selective metastructure layer is adhesively bonded to a first surface of a polystyrene foam board, and a quartz fiber fabric/epoxy composite side of the second frequency-selective metastructure layer is adhesively bonded to a second surface of the polystyrene foam board with a thickness h of 7.9 mm, and compacted, so as to obtain the lightweight frequency-selective metamaterial.

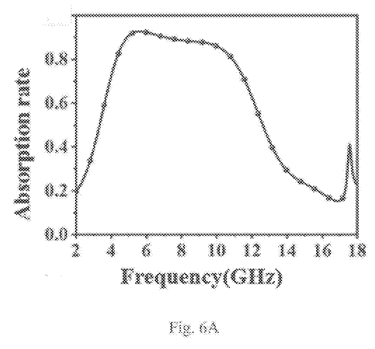

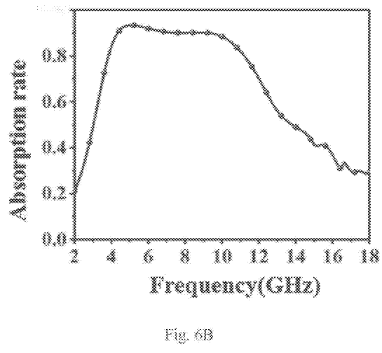

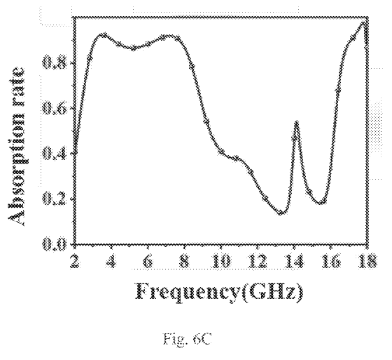

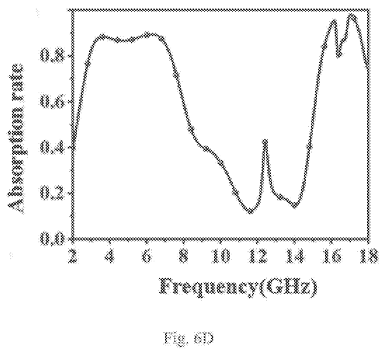

As shown in FIG. 6A, a strong absorption of the lightweight frequency-selective metamaterial prepared herein appears at 5.38 GHz, where a strong absorption rate of 0.93 is generated. Moreover, an effective absorption bandwidth (S₁₁≤-10 dB and S₂₁≤-10 dB) reaches 5.48 GHz (4.60-10.08 GHz).

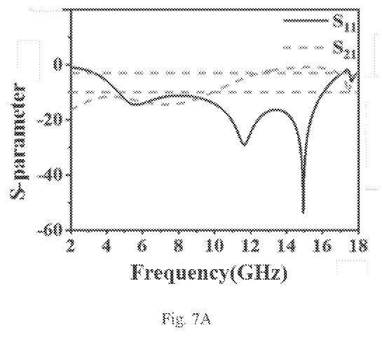

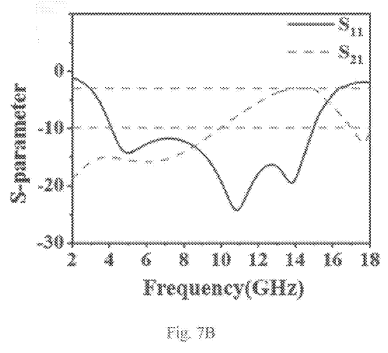

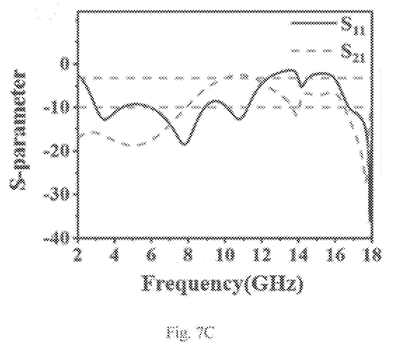

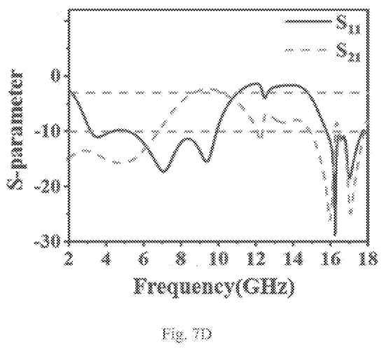

As shown in FIG. 7A, a minimum insertion loss (IL) of the lightweight frequency-selective metamaterial prepared herein is -1.14 dB, which appears at 15.12 GHz, and the corresponding transmissivity can reach over 70%. Moreover, an effective transmission bandwidth (S₁₁≤-10 dB and S₂₁≥-3 dB) is achieved within 12.54-16.88 GHz.

### EXAMPLE 2

The method for preparing the lightweight frequency-selective metamaterial is the same as Example 1, except that the first carbon fiber veil used in the unit structure of the first frequency-selective metastructure layer has an areal density of 40 g/m² and a sheet resistance of 5 Ω/sq. The second carbon fiber veil used in the unit structure of the second frequency-selective metastructure layer has an areal density of 10 g/m² and a sheet resistance of 20 Ω/sq. In the unit structure of the first frequency-selective metastructure layer, the first carbon fiber veil has a thickness of 0.05 mm and the first quartz fiber fabric/epoxy resin composite has a thickness of 0.5 mm. In the unit structure of the second frequency-selective metastructure layer, the second carbon fiber veil has a thickness of 1 mm and the second quartz fiber fabric/epoxy resin composite has a thickness of 5 mm.

The structural parameters are as follows: a₁and b are 15.23 mm, a₂ is 9.10 mm, b₁is 15.00 mm, b₂ is 1.51 mm, and h is 3.20 mm.

As shown in FIG. 6B, a strong absorption of the lightweight frequency-selective metamaterial prepared herein appears at 4.98 GHz, where a strong absorption rate of 0.94 is generated. Moreover, an effective absorption bandwidth (S₁₁≤–10 dB and S₂₁≤–10 dB) reaches 5.95 GHz (4.09-10.04 GHz).

As shown in FIG. 7B, a minimum IL of the lightweight frequency-selective metamaterial prepared herein is -1.95 dB, which appears at 14.43 GHz, and the corresponding transmissivity can reach over 60%. Moreover, an effective transmission bandwidth (S₁₁≤-10 dB and S₂₁≥-3 dB) is achieved within 12.80-15 GHz.

### EXAMPLE 3

The method for preparing the lightweight frequency-selective metamaterial is the same as Example 1, except that the first carbon fiber veil used in the unit structure of the first frequency-selective metastructure layer has an areal density of 70 g/m² and a sheet resistance of 3.5 Ω/sq. The second carbon fiber veil used in the unit structure of the second frequency-selective metastructure layer has an areal density of 20 g/m² and a sheet resistance of 15 Ω/sq. In the unit structure of the first frequency-selective metastructure layer, the first carbon fiber veil has a thickness of 1 mm and the first quartz fiber fabric/epoxy resin composite has a thickness of 0.5 mm. In the unit structure of the second frequency-selective metastructure layer, the second carbon fiber veil has a thickness of 1 mm and the second quartz fiber fabric-epoxy resin composite has a thickness of 0.5 mm.

The structural parameters are as follows: a₁ and b are 20.45 mm, a₂ is 11.74 mm, b₁ is 19 mm, b₂ is 3.00 mm, and h is 8.30 mm.

As shown in FIG. 6C, a strong absorption of the lightweight frequency-selective metamaterial prepared herein appears at 17.75 GHz, where a strong absorption rate of 0.98 is generated. Moreover, an effective absorption bandwidth (S₁₁≤–10 dB and S₂₁≤–10 dB) reaches 4.7 GHz (2.98-4.55 GHz, 6.15-8 GHz and 16.72-18 GHz).

As shown in FIG. 7C, a minimum IL of the lightweight frequency-selective metamaterial prepared herein is -2.39 dB, which appears at 10.79 GHz, and the corresponding transmissivity can reach over 50%. Moreover, an effective transmission bandwidth (S₁₁≤-10 dB and S₂₁≥-3 dB) is achieved within 10.06-11.41 GHz.

### EXAMPLE 4

The method for preparing the lightweight frequency-selective metamaterial is the same as Example 1, except that the first carbon fiber veil used in the unit structure of the first frequency-selective metastructure layer has an areal density of 80g/m² and a sheet resistance of 3 Ω/sq. The second carbon fiber veil used in the unit structure of the second frequency-selective metastructure layer has an areal density of 5 g/m² and a sheet resistance of 25 Ω/sq. In the unit structure of the first frequency-selective metastructure layer, the first carbon fiber veil has a thickness of 1 mm and the first quartz fiber fabric/epoxy resin composite has a thickness of 5 mm. In the unit structure of the second frequency-selective metastructure layer, the second carbon fiber veil has a thickness of 0.05 mm and the second quartz fiber fabric/epoxy resin composite has a thickness of 0.5 mm.

The structural parameters are as follows: a₁ and b are 23.71 mm, a₂ is 14.33 mm, b₁is 20.75 mm, b₂ is 3.25 mm, and h is 9.16 mm.

As shown in FIG. 6D, a strong absorption of the lightweight frequency-selective metamaterial prepared herein appears at 17.02 GHz, where a strong absorption rate of 0.99 is generated. Moreover, an effective absorption bandwidth (S₁₁≤–10 dB and S₂₁≤–10 dB) reaches 5.87 GHz (3.17-6.88 GHz and 15.84-18 GHz).

As shown in FIG. 7D, a minimum IL of the lightweight frequency-selective metamaterial prepared herein is -2.20 dB, which appears at 9.48 GHz, and the corresponding transmissivity can reach over 50%. Moreover, an effective transmission bandwidth (S₁₁≤-10 dB and S₂₁≥-3 dB) is achieved within 8.64-10.15 GHz.

As shown in FIGS. 6A-6D, all the lightweight frequency-selective metamaterial obtained in Example 1-4 achieve absorption rates greater than 0.9 at different frequencies; in particular, main absorption bands of Examples 1 and 2 are concentrated below 12 GHz, while Examples 3 and 4 exhibit high absorption not only in the low-frequency range but also in the high-frequency range above 16 GHz.

As shown in FIGS. 7A-7D, all the lightweight frequency-selective metamaterial obtained in Example 1-4 exhibit an insertion loss (IL) of less than -3 dB across different frequencies; specifically, main transmission bands of Examples 1 and 2 are concentrated in the high-frequency range above 13 GHz, while those of Examples 3 and 4 are located in the mid-frequency range of 8-10 GHz.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A carbon fiber veil-based frequency-selective metamaterial with integrated absorption-transmission to electromagnetic waves, comprising:
a symmetric structure composed of n × n units arranged periodically;
wherein n is a positive integer; each of the n × n units comprises a first frequency-selective metastructure layer, a dielectric layer, and a second frequency-selective metastructure layer laminated in sequence from bottom to top; and the second frequency-selective metastructure layer is a lossy frequency-selective metastructure layer;
a unit structure of the first frequency-selective metastructure layer has a square-ring shape having an outer-side length a₁15-23-23of 15.23-23.71 mm and an inner-side length a₂9-14of 9.10 -14.33 mm, and a₂ < a₁;
the unit structure of the first frequency-selective metastructure layer is fabricated by laminating a first carbon fiber veil having a sheet resistance of 3-5 Ω/sq and an areal density of 40-80 g/m² with a first quartz fiber fabric/epoxy composite;
a center of the unit structure of the first frequency-selective metastructure layer has a square-shaped recess with the first carbon fiber veil removed to expose the first quartz fiber fabric/epoxy composite, such that the square-shaped recess is surrounded by peripheral edges covered with the first carbon fiber veil;
the first frequency-selective metastructure layer has a reflection behavior similar to that of a perfect electric conductor within an absorption band, and offers a transmission effect within a transmission band via an inductor-capacitor (LC) parallel resonance;
a unit structure of the dielectric layer is square, and has a side length of a₁ and a thickness h3-20-9of 3.20-9.16 mm;
in response to a case that h varies within a range of 3.20-9.16 mm, an absorption band and a transmission band of the frequency-selective metamaterial remain near a series resonance point of the second frequency-selective metastructure layer and a parallel resonance point of the first frequency-selective metastructure layer, respectively;
the dielectric layer is made of a polystyrene foam board;
a unit structure of the second frequency-selective metastructure layer has a cross shape, and has a unit size of b, b=a₁ an arm length b₁15-00-20 of 15.00-20.75 mm and an arm width b₂1-51-3of 1.51-3.25 mm, wherein b₂ < b₁ < b;
the unit structure of the second frequency-selective metastructure layer is fabricated by laminating a second carbon fiber veil having a sheet resistance of 4-25 Ω/sq and an areal density of 5-50 g/m² with a second quartz fiber fabric/epoxy composite;
the unit structure of the second frequency-selective metastructure layer has a cross-shaped protrusion formed by removing the second carbon fiber veil within peripheral regions to expose the second quartz fiber fabric/epoxy composite;
the second frequency-selective metastructure layer achieves impedance matching through LC series resonance within the absorption band, and offers a transmission effect via LC parallel resonance within the transmission band; and
the second frequency-selective metastructure layer as a top layer and the first frequency-selective metastructure layer as a bottom layer are configured to jointly produce parallel resonance within the transmission band to enable effective transmission of the electromagnetic waves.

2. The frequency-selective metamaterial according to claim 1, wherein the first carbon fiber veil has a thickness of 0.05-1 mm; and the first quartz fiber fabric/epoxy composite has a thickness of 0.5-5 mm.

3. The frequency-selective metamaterial according to claim 1, wherein the second carbon fiber veil has a thickness of 0.05-1 mm; and the second quartz fiber fabric/epoxy composite has a thickness of 0.5-5 mm.

4. The frequency-selective metamaterial according to claim 1, wherein the unit structure of the first frequency-selective metastructure layer, the unit structure of the dielectric layer, and the unit structure of the second frequency-selective metastructure layer are arranged in a one-to-one correspondence manner from bottom to top.
